(19) United States
(12) Patent Application Publication
(10) Pub. No.: US 2020/0213679 A1
(43) Pub. Date: Jul. 2, 2020

(54) INFORMATION PROCESSING APPARATUS, INFORMATION PROCESSING METHOD, AND PROGRAM

(71) Applicant: Sony Corporation, Tokyo (JP)

(72) Inventors: Yoshinori KURATA, Ibaraki (JP); Manabu KII, Tokyo (JP)

(73) Assignee: Sony Corporation, Tokyo (JP)

(21) Appl. No.: 16/633,588

(22) PCT Filed: May 23, 2018
(86) PCT No.: PCT/JP2018/019778

§ 371 Date: Jan. 24, 2020

(30) Foreign Application Priority Data
Jul. 31, 2017 (JP) 2017-148240

(51) Int. Cl. H04N 21/81; H04N 21/854; H04N 21/488; H04N 21/84

(52) U.S. Cl. CPC H04N 21/8126; H04N 21/84; H04N 21/4882; H04N 21/854

(57) ABSTRACT

[Problem] The cost for generating a program content containing visual information can be reduced.

[Solution] Provided is an information processing apparatus including a control unit that acquires material data, analyzes a matter of the material data, and automatically generates program content data based on the matter, wherein the program content data includes visual information.

### FIELD

The present disclosure relates to an information processing apparatus, an information processing method, and a program.

### BACKGROUND

In recent years, along with progress of an information processing technique, developed are various generation methods or provision methods of a program content to be broadcasted on television, the radio, a moving image distribution site of the Internet, or the like.

For example, Patent Literature 1 illustrated below discloses a technique of generating a program content by combining various kinds of text information provided on a website such as news, a weather, and a Twitter feed with audio data such as a musical piece and a technique of voice-outputting the generated program content.

### CITATION LIST

### Patent Literature

Patent Literature 1: JP 6065019 B2

### SUMMARY

### Technical Problem

However, depending on the technique or the like disclosed in Patent Literature 1, it is difficult to reduce the cost for generating a program content containing visual information. For example, the technique disclosed in Patent Literature 1 can reduce the cost for generating a program content containing voice but has difficulty in reducing the cost for generating a program content containing visual information such as a moving image and a still image.

The present disclosure is accomplished by taking such problems as mentioned above into consideration thereof and provides a novel and improved information processing apparatus, information processing method, and a program enabling the cost for generating a program content containing visual information to be reduced.

### Solution to Problem

According to the present disclosure, an information processing apparatus is provided that includes: a control unit that acquires material data, analyzes a matter of the material data, and automatically generates program content data based on the matter, wherein the program content data includes visual information.

Moreover, according to the present disclosure, an information processing method executed by a computer is provided that includes: acquiring material data, analyzing a matter of the material data, and automatically generating program content data based on the matter, wherein the program content data includes visual information.

Moreover, according to the present disclosure, a program t is provided that causes a computer to fulfill acquiring material data, analyzing a matter of the material data, and automatically generating program content data based on the matter, wherein the program content data includes visual information.

### Advantageous Effects of Invention

As described above, according to the present disclosure, the cost for generating a program content containing visual information can be reduced.

Meanwhile, effects are not necessarily limited to the above effects. In addition to or instead of the above effects, any effects described in the present description or other effects that can be construed from the present description may be exerted.

### BRIEF DESCRIPTION OF DRAWINGS

FIG. 1 illustrates a configuration of a program provision system according to an embodiment of the present disclosure.

FIG. 2 illustrates an example of “a genre”, which is information to be input by a preparer of a program content.

FIG. 3 illustrates an example of “a kind”, which is information to be input by the preparer of the program content.

FIG. 4 illustrates an example of “a template”, which is information to be input by the preparer of the program content.

FIG. 5 illustrates an example of a plurality of manuscript data pieces in a case in which the plurality of manuscript data pieces having different replay time periods for certain report information are generated.

FIG. 6 describes a function of adapting visual information to information to be reported, replay time and date, or the like.

FIG. 7 describes a function of automatically adding movement of a character.

FIG. 8 is a block diagram illustrating an example of functional components that a distribution apparatus includes.

FIG. 9 is a block diagram illustrating an example of functional components that a user terminal includes.

FIG. 10 is a flowchart illustrating an example of an operation of the distribution apparatus.

FIG. 11 is a flowchart illustrating an example of an operation of the user terminal.

FIG. 12 is a block diagram illustrating an example of a hardware configuration of the distribution apparatus and the user terminal.

### DESCRIPTION OF EMBODIMENTS

A preferred embodiment of the present disclosure will be described below in detail with reference to the attached drawings. Meanwhile, in the present description and drawings, components having a substantially equal functional configuration are labeled with the same reference signs, and description of the duplicate components is omitted.

Note that description will be provided in the following order.

1. Background

2. Configuration of Program Provision System

3. Function Overview

4. Functional Components

5. Operation

6. Hardware Configuration

7. Conclusion

### 1. BACKGROUND

First, a background of the present disclosure will be described.

A program content to be broadcasted on television, the radio, a moving image distribution site of the Internet, or the like includes a manuscript prepared in advance, an ad-lib of a speaker (for example, an announcer, a master of ceremonies, or a radio personality), and the like.

More specifically, the speaker adds, changes, or deletes a matter to be reported based on his/her skills, experiences, and the like to adjust the length of the program content so that the program content may end in preset broadcast time. For example, in a case in which the amount of the matter of the manuscript is larger than the amount that can be reported in the remaining broadcast time, the speaker omits a lower-priority matter and changes the manuscript into shorter expression to do adjustment so that higher-priority information may be reported and so that the program content may end in the broadcast time.

Also, in a case in which there are a plurality of manuscripts, the speaker appropriately inserts a conjunction (for example, “now”, “next”, “so”, or “by the way”), an ad-lib, or the like after finishing reading a manuscript before starting reading the next manuscript to smoothly move from a manuscript to another.

Also, there is a case in which the speaker inserts an ad-lib in accordance with users' watching and listening situations. For example, in a case in which information reported before is to be reported again, there is a case in which the speaker inserts an ad-lib such as “as reported earlier” as an introduction part of the matter of the manuscript. Also, in a case in which new information not reported before is to be reported, there is a case in which the speaker inserts an ad-lib such as “we have new information about”.

Also, in a case in which emergency information (e.g., highly important information such as disaster information) is required to be reported, the speaker gives priority to reporting of the emergency information by reporting the emergency information in the middle of reporting information or changing the order of information reporting.

Also, there is a case in which the speaker reports information using gestures such as body and hand motions in accordance with a matter of information to be reported. For example, in a weather forecast, there is a case in which the speaker reports information while indicating a part of a weather map with a pointer or looking at a moving image or a still image displayed.

Also, the speaker appropriately changes his/her facial expression, tone of voice, or the like based on a matter to be reported. For example, in a case in which a matter to be reported is sad news (for example, occurrence of an accident or a disaster or a person's death), the speaker reports the information with a sad face and a low tone of voice. Conversely, in a case in which a matter to be reported is good news (for example, a marriage, a childbirth, or winning in a competition), the speaker reports the information with a happy face and a high tone of voice. Also, not only the facial expression or tone of voice but also the speaker's dress, BGM, a background, or the like is changed based on a matter to be reported in some cases.

Also, the BGM, the background, the speaker's facial expression, tone of voice, or dress, or the like is changed based not only on the matter to be reported but also on time and date, or an area to replay the program content, or a season, a weather, or a temperature at the time of replay in some cases. For example, in a case in which the season at the time of replay is summer, there is a case in which the speaker's dress is summer wear, and in which the BGM and the background are music and a background that are associated with summer.

Based on the above, to prepare one program content, many tasks are performed such as preparation for a manuscript, determination and acquisition of dress, determination and edit of BGM, determination, preparation, and installation of a background, determination of camera work, casting of a speaker, meeting with the speaker, consideration of a matter of an ad-lib delivered by the speaker, a rehearsal, real filming, edit, and broadcasting. This tends to increase the cost for preparing the program content. Also, the quality of the program content (whether or not viewers can watch or listen comfortably, whether or not an ad-lib is appropriate, etc.), whether or not the program content ends in broadcast time, and the like depend on the speaker's skills, experiences, and the like.

In consideration of the above circumstances, the present discloser has arrived at the present disclosure. In the present disclosure, material data is acquired, a matter of the material data is analyzed, and a program content containing visual information can automatically be generated based on the matter. Hereinbelow, a program provision system according to an embodiment of the present disclosure will be described in detail.

### 2. CONFIGURATION OF PROGRAM PROVISION SYSTEM

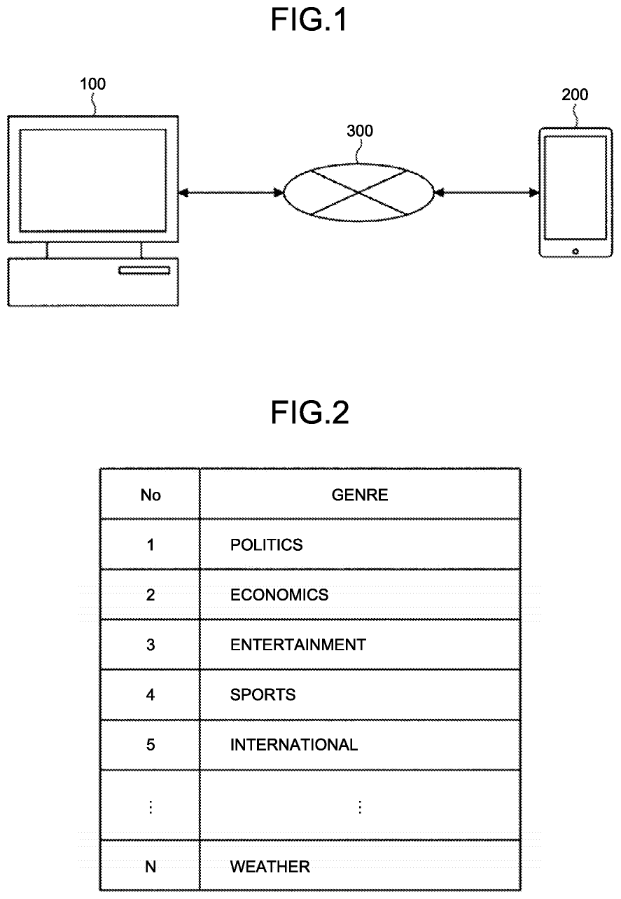

The background of the present disclosure has been described above. Next, referring to FIG. 1, a configuration of a program provision system according to an embodiment of the present disclosure will be described.

As illustrated in FIG. 1, the program provision system according to the present embodiment includes a distribution apparatus 100 and a user terminal 200, and the distribution apparatus 100 and the user terminal 200 are connected via a network 300.

The distribution apparatus 100 is an information processing apparatus having a function of automatically generating and distributing a program content. More specifically, when a preparer of a program content inputs material data which is a basis of the program content into the distribution apparatus 100, the distribution apparatus 100 automatically generates the program content containing visual information based on a matter of the material data.

For example, the distribution apparatus 100 generates manuscript data based on document data input as material data. The distribution apparatus 100 then generates a program content containing visual information based on the manuscript data and moving image data, still image data, or the like input as material data. Here, the program content may enable voice to be output by performing voice synthesis processing to the manuscript data, may enable the manuscript data to be displayed as a caption, or may enable an arbitrary character, for example, other than the input moving image data or still image data, to be displayed. Also, the program content includes a content to be broadcasted on television, a content to be distributed on a moving image distribution site of the Internet, a content to be displayed on a predetermined advertising medium, a content to be broadcasted on the radio, and the like and is not limited to these. Details of a matter and a generation method of the program content will be described below.

The distribution apparatus 100 then provides the user terminal 200 with the generated program content to provide a viewer with the program content. More specifically, the distribution apparatus 100 uploads the program content on a server (for example, a World Wide Web (WEB) server administering a specific WEB site on the Internet) accessible by the user terminal 200, and the user terminal 200 downloads the program content from the server. Meanwhile, a method for providing the program content is not limited to this. For example, the user terminal 200 may directly access the distribution apparatus 100 via the network 300 to acquire the program content. Also, push-based distribution may be performed, not pull-based distribution, in which the user terminal 200 downloads the program content.

The user terminal 200 is an information processing apparatus having a function of replaying the program content distributed by the distribution apparatus 100. More specifically, the user terminal 200 replays the program content selected based on an operation of the viewer with use of an output unit (for example, a display or a loudspeaker) provided in the terminal itself.

Also, the user terminal 200 has a function of editing the program content generated by the distribution apparatus 100. For example, the user terminal 200 has a function of editing a matter (a matter of manuscript data, moving image data, still image data, BGM, or the like) or a replaying method (for example, display size, volume, speed, or the like) of the program content based on setting by the viewer, the viewer's preference information, or the like. The user terminal 200 also has a function of generating a program content with use of material data that the distribution apparatus 100 has partially processed. For example, the user terminal 200 has a function of generating a program content with use of material data that has undergone on the distribution apparatus 100 denoising by means of filtering, trimming, format conversion, and the like.

Meanwhile, in the present description, the above case in which a program content generated by the distribution apparatus 100 is replayed or edited by the user terminal 200 will be illustrated. However, various kinds of processing may be executed either by the distribution apparatus 100 or by the user terminal 200 (in other words, the distribution apparatus 100 and the user terminal 200 can have equal functional components to each other). For example, the distribution apparatus 100 may distribute data (material data itself or data obtained by processing the material data) which is a basis of the program content, and the user terminal 200 may automatically generate and replay the program content with use of the data and the viewer's preference information or the like. Also, the user terminal 200 may provide the viewer's preference information or the like to the distribution apparatus 100, and the distribution apparatus 100 may distribute to the user terminal 200 the program content that the distribution apparatus 100 has automatically generated with use of the information.

Each of the distribution apparatus 100 and the user terminal 200 is a desktop-type, notebook-type, or tablet-type personal computer (PC), a smartphone, a general-purpose computer, any one of various wearable terminals (for example, a glasses-type terminal, a watch-type terminal, a cloth-type terminal, a ring-type terminal, a bracelet-type terminal, an earring-type terminal, or a necklace-type terminal), or a head-mounted display, for example, and is not limited to these.

The network 300 is a wired or wireless transmission path for information communicated by the distribution apparatus 100 and the user terminal 200 connected to the network 300. For example, the network 300 may include a public line network such as the Internet and various Local Area Networks (LAN) such as Ethernet (registered trademark), a Wide Area Network (WAN), and the like. The network 300 may also include a dedicated line network such as Internet Protocol-Virtual Private Network (IP-VPN) and a short-range wireless communication network such as Bluetooth (registered trademark).

Meanwhile, the configuration in FIG. 1 is illustrative only, and a configuration of the program provision system according to the present embodiment is not limited to this. For example, as described above, the program provision system according to the present embodiment may include either the distribution apparatus 100 or the user terminal 200.

### 3. FUNCTION OVERVIEW

The configuration of the program provision system according to the embodiment of the present disclosure has been described above. Next, a function overview of the program provision system according to the present embodiment will be described.

(3-1. Manuscript Generation Function)

The program provision system according to the present embodiment has a function of automatically generating manuscript data to be broadcasted.

More specifically, the distribution apparatus 100 is first provided as material data with document data and a genre or a kind of a matter of the document data, or information about a template.

Here, the document data is assumed to be a text file or a data file generated with use of word-processing software and is not limited to these. For example, the document data may be an image file displaying a document, and the distribution apparatus 100 may analyze the image file and extract the document. Also, a single piece or plural pieces of document data may be used.

Also, the genre of the matter of the document data is a category of information to be reported. Examples thereof are “Politics”, “Economics”, “Entertainment”, “Sports”, “International”, and “Weather” as illustrated in FIG. 2 without limitation. For example, the genre may be one obtained by subdividing the above genre (for example, “Weather”) such as “Japan Weather”, “Tokyo Weather”, “Weekly Weather”, and “Daily Weather”. Meanwhile, input of the genre is not mandatory.

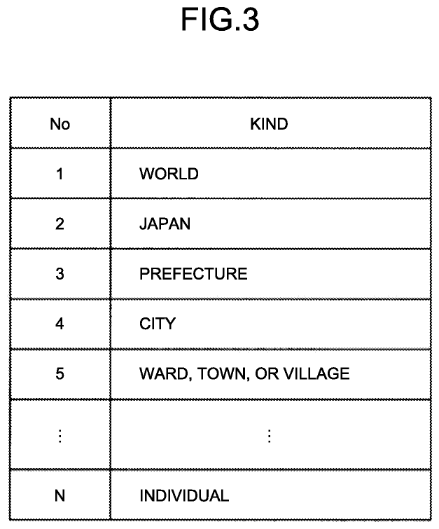

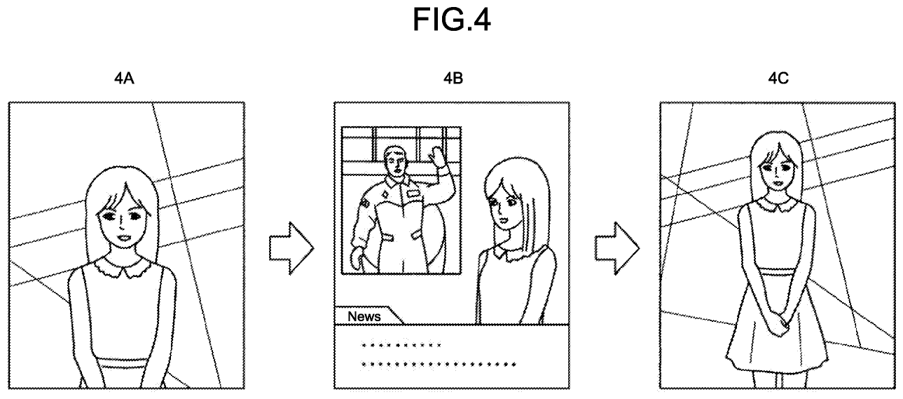

Also, the kind of the matter of the document data is one obtained by classifying information to be reported by certain kind. Examples thereof are “World”, “Japan”, “Prefecture”, “City”, “Ward, Town, or Village”, and “Individual”, which are ones obtained by classifying the information by kind of a range targeted for information reporting as illustrated in FIG. 3 without limitation. For example, the kind of the matter of the document data may be one obtained by classifying the information by kind of a person targeted for information reporting such as “Male”, “Female”, “Elderly”, and “Child”, one obtained by classifying the information by kind of an emergency level of information reporting such as “Emergent” and “Normal”, or one obtained by classifying the information by kind of a matter of the information such as “Sad News” and “Good News”. Meanwhile, input of the kind is not mandatory.

The template is information indicating a construction pattern of the program content. For example, the template is a construction pattern including “Opening (4A)”, “Topic (4B)”, and “Ending (4C)” as illustrated in FIG. 4. Meanwhile, the template is not limited to the example in FIG. 4 and may be a construction pattern in which any of “Opening (4A)”, “Topic (4B)”, and “Ending (4C)” is omitted or a construction pattern in which other components than these are added, for example. Also, the template may be information in which settings of camerawork, a screen construction (e.g., a positional relationship among a character, a moving image, a still image, and a telop), whether or not a character is present, an attribute of the character (e.g., gender, age, voice quality, dress, and a kind of the character in a case in which the character is not a human being (an animal or the like)), whether or not voice is generated, and the like are added. The template may be prepared by the preparer or may automatically be generated based on a result of learning of an existing program (for example, a television program, an Internet distribution program, or a radio program). By selecting such a template, the preparer can cause the distribution apparatus 100 to generate a desired program content. Meanwhile, input of the template is not mandatory.

The distribution apparatus 100 automatically generates manuscript data based on the above various kinds of information input. More specifically, the distribution apparatus 100 analyzes the input document data and comprehends the matter of the document data. For example, the distribution apparatus 100 extracts a word included in the document data and recognizes a matter of the word with use of information stored in the distribution apparatus 100 itself, information acquired from an external device (for example, an external WEB server), or the like. Consequently, the distribution apparatus 100 can recognize a genre, a kind, or the like of the matter of the document data based on the result of analysis of the document data conducted by itself and can use the genre, the kind, or the like, as well as the input genre or kind, for subsequent processing.

The distribution apparatus 100 then automatically generates manuscript data to be broadcasted based on the genre, the kind, the template, the result of analysis of the document data, and the like. More specifically, the distribution apparatus 100 automatically generates manuscript data by deleting or changing a part of the input document data or adding information that is not contained in the document data.

Here, automatic generation of manuscript data will be described, taking as an example a case in which the template in FIG. 4 is used. For example, suppose that document data about information to be broadcasted in Topic (4B) is input into the distribution apparatus 100. With use of the input document data, the distribution apparatus 100 automatically generates manuscript data to be broadcasted in Topic (4B) and manuscript data to be broadcasted in Opening (4A) and Ending (4C).

In generating manuscript data to be broadcasted in Opening (4A), Topic (4B), and Ending (4C), the distribution apparatus 100 adds matters that are not contained in the input document data based on a matter of information to be reported, time and date, or an area to replay the program content data, or a season, a weather, or a temperature at the time of replay. For example, the distribution apparatus 100 may add to Opening (4A) a matter based on the time and date of replay of the program content data such as “A happy new year. Here is the news of Jan. 1, 2017.”. Also, the distribution apparatus 100 may add to the beginning of Topic (4B) a matter based on a matter of information to be reported such as “Sad news has just come in”. Also, the distribution apparatus 100 may add to Ending (4C) a matter based on an area to replay the data and a weather at the time of replay such as “It will rain heavily in Tokyo some time during the period from 10 AM to 3 PM. Be sure to take your umbrella with you.”.

Also, a matter that fits the viewer's behavior, the viewer's situation (or environment), or the like may be added. More specifically, the distribution apparatus 100 (or the user terminal 200) may analyze data acquired from any of various sensors (for example, an acceleration sensor, a gyro sensor, or a pressure sensor) of a wearable terminal worn by the viewer, recognize the viewer's behavior, the viewer's situation, or the like, and add a matter that fits them. For example, in a case in which the distribution apparatus 100 or the like recognizes that the viewer is on the way to work, the distribution apparatus 100 or the like may add to Ending (4C) a matter such as “Try your best at work today.”.

Also, the distribution apparatus 100 or the like may analyze the above sensing data or the like to predict the viewer's behavior, the viewer's situation (or environment), or the like at some point in the future and add a matter that fits the prediction result. For example, in a case in which the distribution apparatus 100 or the like recognizes that the viewer has got on a vehicle (for example, a train or a car) on the way to work, the distribution apparatus 100 or the like may add a matter such as “Try your best at work today.” at time when the viewer gets off the vehicle which is predicted based on the previous behavior history. Meanwhile, the above matter to be added may be one that is automatically generated in advance by input of other document data.

Also, the distribution apparatus 100 deletes or changes a part of the input document data. For example, in a case in which the matter added as above contains a matter that overlaps with the input document data (for example, in a case in which a matter “Here is the news of Jan. 1, 2017.” is added, and in which a similar matter is contained in the document data), the distribution apparatus 100 may delete or change the overlapping part in the document data. Also, in a case in which the same word appears frequently, or in a case in which a difficult word exists, the distribution apparatus 100 may change the word into a different expression as needed.

Meanwhile, the distribution apparatus 100 may generate the manuscript data without changing the document data serving as the material data. For example, in a case in which it is prohibited to change the document data for some reasons (for example, in a case in which the document data is protected by copyright), the distribution apparatus 100 may generate the manuscript data by adjusting a matter to be added before and after the input document data without changing the document data. At this time, since the distribution apparatus 100 adjusts manuscript reading speed or appropriately gives a pause, the viewer can be less likely to feel strange (meanwhile, adjustment of replay time will be described below).

Accordingly, the distribution apparatus 100 can generate as high-quality a program content as one provided by a speaker (for example, an announcer, a master of ceremonies, or a radio personality) with an ad-lib and can reduce the cost for generating the program content. Also, the preparer of the program content can focus on preparing the document data, which is core information.

Also, in a program content the broadcast time of which is determined in advance, the distribution apparatus 100 can generate manuscript data so that the program content may end in the broadcast time. More specifically, the distribution apparatus 100 calculates replay time of voice data at the time of generating the manuscript data. For example, the distribution apparatus 100 calculates replay time of voice data after voice synthesis for the manuscript data based on matters of various parameters for use in the voice synthesis.

In a case in which replay time of the generated manuscript data (or the manuscript data which is being generated) is longer than the predetermined broadcast time, the distribution apparatus 100 edits the manuscript data. For example, the distribution apparatus 100 edits the manuscript data so that the replay time of the manuscript data may be as long as the predetermined broadcast time by deleting low-priority information from the input document data, changing the document data into a different expression, or deleting or changing an added matter. Conversely, in a case in which the replay time of the generated manuscript data (or the manuscript data which is being generated) is shorter than the predetermined broadcast time, the distribution apparatus 100 edits the manuscript data so that the replay time of the manuscript data may be as long as the predetermined broadcast time by changing the input document data into a different expression, changing an added matter, or adding a new different matter.

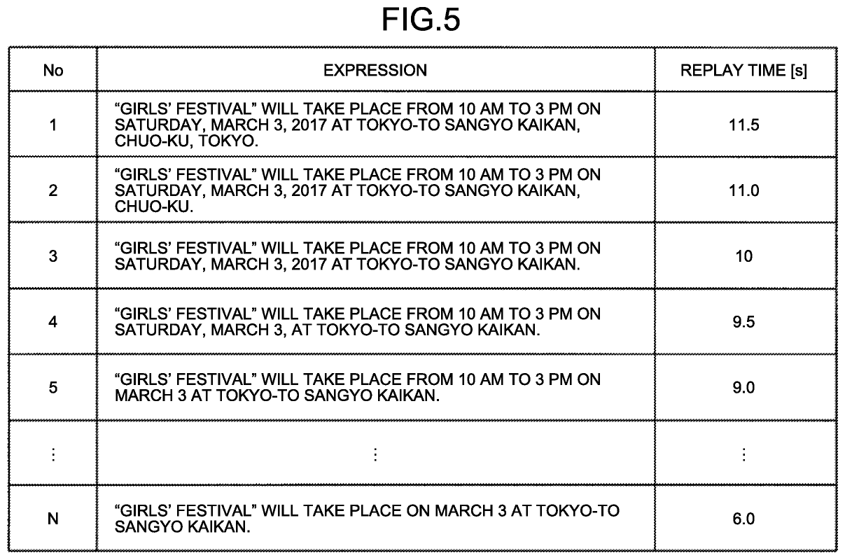

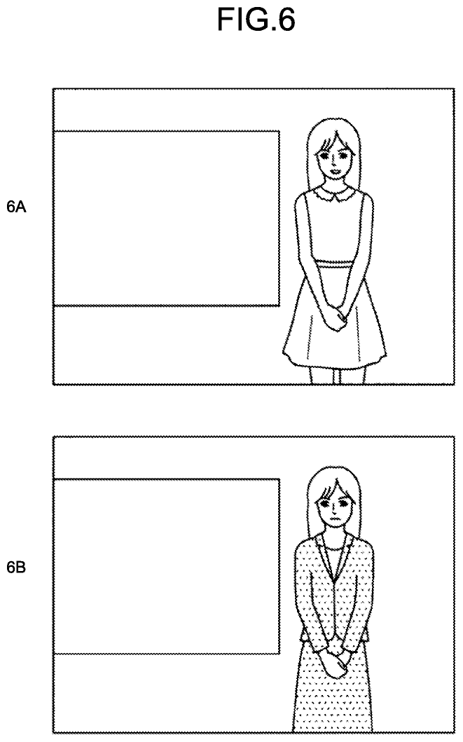

Here, the distribution apparatus 100 may generate a plurality of manuscript data pieces having different replay time periods for certain report information and select an appropriate manuscript data piece from the plurality of manuscript data pieces to generate manuscript data that ends in the broadcast time. For example, the distribution apparatus 100 analyzes input document data and, based on the analysis result, generates a plurality of manuscript data pieces which have different replay time periods and which can be understood by the viewer, as illustrated in FIG. 5. The distribution apparatus 100 may then select an appropriate manuscript data piece from the plurality of manuscript data pieces based on the broadcast time, manuscript data for other report information, or the like to achieve generation of manuscript data that ends in the broadcast time. Meanwhile, the distribution apparatus 100 may provide the preparer with a list illustrated in FIG. 5 to let the preparer select a desired manuscript data piece from the plurality of manuscript data pieces.

As a result of the above, the distribution apparatus 100 can be operated in a manner in which the speaker (for example, an announcer, a master of ceremonies, or a radio personality) changes a matter to be reported, a way of expression, speaking speed, or the like based on the information that is required to be reported and the remaining broadcast time and can end the program content in the broadcast time.

(3-2. Function of Generating Sound or Visual Information)

The program provision system according to the present embodiment also has a function of automatically generating a sound or visual information of a program content.

More specifically, the distribution apparatus 100 is provided as material data with moving image data, still image data, or the like. The distribution apparatus 100 then automatically generates a program content containing a sound or visual information with use of these data pieces, the information set above (the genre, the kind, the template, or the like), and the manuscript data generated above.

For example, the distribution apparatus 100 generates a program content containing voice data by means of voice synthesis processing using the generated manuscript data. The distribution apparatus 100 can also add a certain sound (for example, BGM or a sound effect), not only voice. Also, the distribution apparatus 100 may add a certain sound based on an analysis result of input material data. For example, in a case in which the distribution apparatus 100 analyzes that the material data is moving image data or the like regarding a sport competition, the distribution apparatus 100 may add theme music for the sport competition as BGM.

Also, the distribution apparatus 100 determines based on the set template a construction pattern of a program content (containing information to which settings of camerawork, a screen construction (e.g., a positional relationship among a character, a moving image, a still image, and a telop), whether or not a character is present, an attribute of the character (e.g., gender, age, voice quality, dress, and a kind of the character in a case in which the character is not a human being (an animal or the like)), whether or not voice is generated, and the like are added). The distribution apparatus 100 then inserts the input moving image data or still image data into a predetermined position at predetermined time in the construction pattern. Specific description will be provided with reference to FIG. 4. The distribution apparatus 100 inserts the input moving image data or still image data into a position on the upper left of the screen in Topic (4B).

At this time, the distribution apparatus 100 may edit the input moving image data or still image data as needed. More specifically, the distribution apparatus 100 analyzes the moving image data or the still image data and recognizes a higher-priority part of the moving image data or the still image data. Meanwhile, the distribution apparatus 100 may refer to a matter of manuscript data in analyzing the moving image data or the still image data. For example, in a case in which the manuscript data contains a word “astronaut”, the distribution apparatus 100 may recognize that the astronaut contained in the moving image data or the still image data is of higher importance. The distribution apparatus 100 may then edit (for example, trimming or change of the aspect ratio) the moving image data or the still image data to enable the higher-priority part to be visually recognized so that the moving image data or the still image data may be inserted into the screen more appropriately.

Accordingly, the distribution apparatus 100 can reduce the cost for generating the program content containing a sound or visual information while keeping the quality of the program content high.

Meanwhile, a method for generating a character to be displayed on the program content is not particularly limited, and an arbitrary technique for generating a two-dimensional animation can be used. For example, a technique may be used for designating a plurality of feature points on an illustration generated by arbitrary software and specifying temporal changes of positional coordinates of the respective feature points to generate a two-dimensional animation. Also, a three-dimensional animation may be generated by using an arbitrary three-dimensional modeling technique (for example, modeling, rendering, or retouching) together.

(3-3. Function of Adapting Sound or Visual Information to Information to be Reported, Replay Time and Date, or the Like)

The program provision system according to the present embodiment also has a function of adapting a sound or visual information to a matter of information to be reported, replay time and date, or the like.

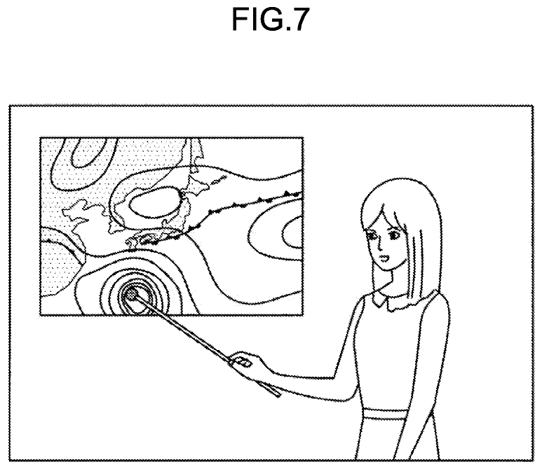

More specifically, the distribution apparatus 100 recognizes a matter of information to be reported based on an analysis result of the information to be reported or set information (a genre, a kind, a template, or the like) and adapts a sound or visual information of the program content to the matter. For example, in a case in which a matter of information to be reported relates to good news, the distribution apparatus 100 determines dress that gives a bright impression to the viewer as dress of a character as illustrated in 6A of FIG. 6. Conversely, in a case in which a matter of information to be reported relates to sad news, the distribution apparatus 100 determines dress that gives a dark impression (or a formal impression) to the viewer as dress of a character as illustrated in 6B of FIG. 6. It is to be understood that specific details of the dress are not limited to FIG. 6. For example, in a case in which a matter of information to be reported relates to a sport competition, the dress of the character may be a uniform or the like of the sport team.

Meanwhile, the distribution apparatus 100 can adapt not only the dress of the character but also BGM, a background, or an attribute, facial expression, or a tone of voice of the character. For example, in a case in which information to be reported is good news, the distribution apparatus 100 may set the BGM, the background, and the character to BGM, a background, and a character that give a bright impression, set the character's facial expression to a happy face, and set the character's tone of voice to a high tone.

Also, the distribution apparatus 100 adapts a sound or visual information to time and date, or an area to replay the program content data, a season, a weather, or a temperature at the time of replay, or the like. For example, in a case in which the season at the time of broadcast is summer, the distribution apparatus 100 may set the BGM and the background to music and a background that are associated with summer, set the character's dress to summer wear, and suntan the character's skin. Meanwhile, the above description is illustrative only, and the distribution apparatus 100 may control a sound or visual information based on information other than time and date, or an area to replay the program content data, or a season, a weather, or a temperature at the time of replay.

Also, the distribution apparatus 100 adapts a sound or visual information to the viewer's behavior, the viewer's situation (or environment), or the like. More specifically, the distribution apparatus 100 analyzes data acquired from any of various sensors (for example, an acceleration sensor, a gyro sensor, or a pressure sensor) of a wearable terminal worn by the viewer, recognizes the viewer's behavior, the viewer's situation, or the like, and adapts a sound and visual information to them. For example, in a case in which the distribution apparatus 100 recognizes that the viewer is spending a holiday in a relaxed state, the distribution apparatus 100 may set the BGM and the background to music and a background enhancing relaxation and set the character's dress to more casual dress. Also, the distribution apparatus 100 may analyze the above sensing data or the like to predict the viewer's behavior, the viewer's situation (or environment), or the like at some point in the future and adapt a sound or visual information to the prediction result.

Also, the controlled target in the above description is not limited to BGM, a background, or an attribute, dress, facial expression, or a tone of voice of the character and may be anything related to a sound or visual information of the program content.

Accordingly, the distribution apparatus 100 can exert a similar effect to the speaker's (for example, an announcer, a master of ceremonies, or a radio personality) changing his/her facial expression and tone of voice and a change of the speaker's dress, BGM, a background, or the like based on a matter of information to be reported, replay time and date, or the like.

(3-4. Function of Adding Character's Movement)

The program provision system according to the present embodiment also has a function of automatically adding a character's movement.

More specifically, the distribution apparatus 100 analyzes input moving image data or still image data and controls movement of a character so that the character may move along with a display position of a target contained in the moving image data or still image data. For example, as illustrated in FIG. 7, in a case in which moving image data regarding changes of a weather map is input, the distribution apparatus 100 analyzes the moving image data and recognizes a display position of the eye of a typhoon displayed on the weather map. The distribution apparatus 100 may let the character's hand move along with the changes of the weather map so that the tip of the pointer may be located at the display position of the eye of the typhoon.

It is to be understood that details of movement control are not limited to the example in FIG. 7. For example, in a case in which moving image data of sport is input, the distribution apparatus 100 may let the character react with joy when a highlight scene is replayed. Also, a target with which the character moves is not particularly limited. For example, a target with which the character moves may be a human being, an animal, an object, light (for example, a firework or illumination), an illustration, a letter, or the like.

Accordingly, the distribution apparatus 100 can exert a similar effect to the speaker's (for example, an announcer, a master of ceremonies, or a radio personality) actually moving in response to a moving image or still image.

(3-5. Function of Requesting Various Kinds of Information)

The program provision system according to the present embodiment also has a function of requesting information to be used in automatic generation of a program content.

More specifically, in a case in which various kinds of information to be used in automatic generation of a program content described above (for example, a genre, a kind, a template, document data, moving image data, or still image data) are insufficient, or in a case in which such information is inappropriate (for example, a case in which the moving image or still image is not clear, or a case in which the moving image is too short or too long), the distribution apparatus 100 can request the preparer to compensate for the insufficient information or provide higher-quality and new information.

Here, a way to request compensation for the insufficient information or the like is not particularly limited. For example, the distribution apparatus 100 may request compensation for the insufficient information or the like with use of an output unit (for example, a display or a loudspeaker) provided in the apparatus itself. At this time, the distribution apparatus 100 may make a definite request to the preparer by clarifying a matter of the insufficient information or a matter of appropriate information, not by merely providing information of “information is insufficient” or “information is inappropriate”.

Accordingly, the distribution apparatus 100 can automatically generate the program content more smoothly. Also, since the distribution apparatus 100 can automatically generate the program content with use of more appropriate information, the distribution apparatus 100 can improve the quality of the program content.

(3-6. Function of Generating (Editing) Manuscript in Accordance with Replay Situation)

The program provision system according to the present embodiment also has a function of automatically generating (or automatically editing) manuscript data in accordance with a situation in which the user replays a program content.

More specifically, the user terminal 200 comprehends a situation in which the viewer replays a program content. For example, the user terminal 200 comprehends a matter of information reported to the viewer in a program content that has all been replayed, a matter of information reported to the viewer in a replayed part of a program content that is being replayed, or the like.

In a case in which a matter of information in the program content to be thereafter reported is equal or similar to the information that has been reported, the user terminal 200 can add a comment such as “as reported earlier” to manuscript data by automatically editing the manuscript data. Also, in a case in which a matter of information in the program content to be thereafter reported is information that has not been reported, the user terminal 200 may add a comment such as “we have new information about” to manuscript data by automatically editing the manuscript data. Meanwhile, the matter of the manuscript data to be edited is not limited to these.

Also, instead of the user terminal 200, the distribution apparatus 100 may fulfill the function. For example, equal or similar information in a program content is reported several times, the distribution apparatus 100 may add a comment such as “as reported earlier” to manuscript data at the time of automatically generating the manuscript data.

Accordingly, the program provision system can exert a similar effect to the speaker's (for example, an announcer, a master of ceremonies, or a radio personality) appropriately inserting an ad-lib in accordance with information reporting situations.

(3-7. Function of Inserting Information of Different Matter)

The program provision system according to the present embodiment also has a function of inserting information of a different matter (or a different program content) into a program content that is being replayed (or a program content that is scheduled to be replayed).

More specifically, the program provision system can set in manuscript data a position in which information of a different matter can be inserted (hereinbelow referred to as “an insertion available position”). Note that examples of the insertion available position are an end position of a program content, an end position of a matter in the program content (for example, a position in which the topic changes), and a position of a punctuation point without limitation.

For example, in a case in which, while the user terminal 200 is replaying a program content, emergency information (e.g., highly important information such as disaster information) is distributed, the user terminal 200 can insert the emergency information into the insertion available position of the program content that is being replayed. At this time, a comment such as “We are interrupting this broadcast to bring you emergency information.” may appropriately be added to the beginning of the emergency information. Meanwhile, the above is illustrative only, and the information to be inserted is not limited to emergency information.

Also, in a case in which information of a different matter is inserted, the information of the different matter may be reported in a program content that is being replayed (for example, a case in which emergency information is reported without changing a character in the program content that is being replayed), or the information of the different matter may be reported by switching the program content that is being replayed into another program content.

Meanwhile, a program content to be replayed after the inserted information of the different matter (in other words, a part that has not been replayed in the program content replayed before insertion) can appropriately be edited. For example, the program content to be replayed after the inserted information of the different matter may be edited to be replayed in an end position of a matter (for example, a position in which the topic changes). Also, a comment such as “That's all we report the emergency information. We are back to the previous program now.” may appropriately be added to the beginning of the program content to be replayed after the inserted information of the different matter. Also, after the information of the different matter is inserted, not the previous program content but another new program content may be replayed.

Note that, in a case in which, at the same time as activation of an alarm, emergency information or the like is displayed on a part of the display (that is, in a case in which emergency information or the like is not reported by means of character voice), the above insertion into the manuscript data or the like is not required.

Accordingly, the program provision system can insert information of a different matter into a program content that is being replayed without making the viewer feel strange.

(3-8. Function of Providing Program Content that has not been Replayed)

The program provision system according to the present embodiment also has a function of providing the viewer with a program content that has not been replayed.

For example, in a case in which, as in the above case, emergency information is inserted in the middle of a program content, and in which there is a part that has not been replayed in the program content, the program provision system can provide the viewer with the part that has not been replayed (or the entire program content containing the part that has not been replayed). Meanwhile, in a case in which a program content is not entirely replayed for some reason, not due to the insertion of emergency information or the like, this function may be used.

Meanwhile, a method for providing the program content that has not been replayed is not particularly limited. For example, the program content that has not been replayed may be provided to a predetermined application (for example, a predetermined application installed in the user terminal 200 or a personalized page on a predetermined WEB site). Also, a program content containing a sound or visual information or only a text file (for example, only a text file of a topic part) may be provided. Also, the viewer may be able to specify a predetermined provision method.

Accordingly, the program provision system can provide the viewer with a program content that the viewer cannot replay for some reason, and convenience for the viewer can be improved.

(3-9. Function or the Like of Editing Program Content Along with Skip or the Like)

The program provision system according to the present embodiment also has a function or the like of editing a program content along with a skip or the like.

More specifically, when the viewer watches or listens to a program content, the viewer can skip a matter of the program content, a commercial, or the like in the middle (or fast-forward it, or replay it at double speed).

For example, in a case in which broadcast time is preset, and in which one or two or more program content(s) is/are replayed to end in the broadcast time, the program content(s) will end earlier than the end of the broadcast time due to the above skip or the like.

Due to this function, in a case in which scheduled replay time of a program content is shortened due to the skip or the like, another program content that is not scheduled to be replayed can automatically be added to prevent the program contents from ending earlier than the end of the broadcast time.

Meanwhile, timing of addition of the other program content is not particularly limited. For example, the other program content may be added at the end of the program content that is scheduled to be replayed at first or between the plurality of program contents.

Also, instead of adding the other program content, a part of the replaying program content that has not been replayed or another program content that is scheduled to be replayed may automatically be edited. For example, replay time of the part of the replaying program content that has not been replayed may be extended. In this case, manuscript data, a sound, or visual information of the part of the program content that has not been replayed are edited. For example, the manuscript data may be edited by employing a way of expression that extends the replay time, or a new matter may be added.

Meanwhile, in a case in which the scheduled replay time of the program content is extended by the user's repetitively replaying the same program content (or rewinding it, replaying it at slow speed, or the like), a program content that is scheduled to be replayed may be deleted or shortened.

Accordingly, even in a case in which the viewer performs an operation such as a skip, the program provision system can end a program content in broadcast time. Also, the program provision system can report as much information as possible within predetermined broadcast time.

### 4. FUNCTIONAL COMPONENTS

The function overview of the program provision system according to the present embodiment has been described above. Next, functional components of the distribution apparatus 100 and the user terminal 200 according to the present embodiment will be described.

As described above, although the distribution apparatus 100 and the user terminal 200 can have equal functional components to each other, in the following description, a case in which the distribution apparatus 100 and the user terminal 200 have different functional components will be described as an example. More specifically, as for the distribution apparatus 100, functional components that generate a program content will be described, and as for the user terminal 200, functional components that generates (or edits) a program content with use of information provided by the distribution apparatus 100 will be described.

(4-1. Functional Components of Distribution Apparatus 100)

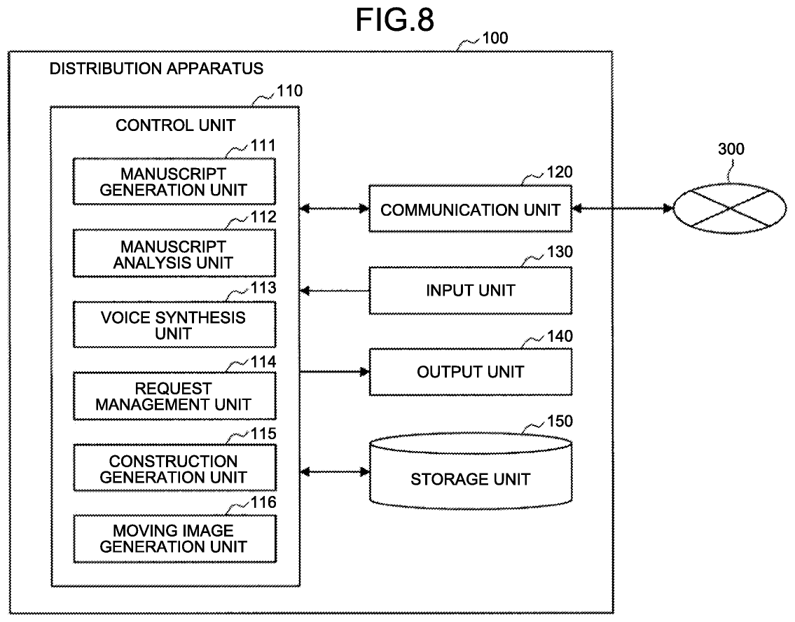

First, referring to FIG. 8, functional components of the distribution apparatus 100 will be described.

As illustrated in FIG. 8, the distribution apparatus 100 includes a control unit 110, a communication unit 120, an input unit 130, an output unit 140, and a storage unit 150.

(Control Unit 110)

The control unit 110 comprehensively controls overall processing of the distribution apparatus 100. For example, the control unit 110 comprehensively controls automatic generation processing of a program content described below and distributes the generated program content data. As illustrated in FIG. 8, the control unit 110 includes a manuscript generation unit 111, a manuscript analysis unit 112, a voice synthesis unit 113, a request management unit 114, a construction generation unit 115, and a moving image generation unit 116. Hereinbelow, the respective functional components included in the control unit 110 will be described.

(Manuscript Generation Unit 111)

The manuscript generation unit 111 is a functional component that automatically generates manuscript data. For example, the manuscript generation unit 111 edits one or two or more document data piece(s) input from the below-mentioned input unit 130 to generate manuscript data.

Meanwhile, at the time of generating the manuscript data, the manuscript generation unit 111 may appropriately regenerate the manuscript data based on control of the below-mentioned construction generation unit 115. For example, in a case in which the construction generation unit 115 determines that the manuscript data is required to be changed based on an analysis result or the like of the manuscript data after the manuscript data is generated, the manuscript generation unit 111 regenerates the manuscript data based on control of the construction generation unit 115. The manuscript generation unit 111 provides the manuscript analysis unit 112 and the voice synthesis unit 113 with the generated manuscript data.

(Manuscript Analysis Unit 112)

The manuscript analysis unit 112 analyzes the manuscript data generated by the manuscript generation unit 111. More specifically, the manuscript analysis unit 112 extracts information about a matter of the manuscript data, e.g., by breaking down the manuscript data and extracting words. Accordingly, the manuscript analysis unit 112 can provide the below-mentioned construction generation unit 115 with information that is not contained in various kinds of information (for example, a genre or a kind) input by the user.

Meanwhile, information that the manuscript analysis unit 112 extracts by means of analysis of the manuscript data is not particularly limited. For example, the manuscript analysis unit 112 may extract a word (for example, “sea”) contained in the manuscript data, information evoked by the word (for example, another word, such as “bathing” and “summer”, evoked by “sea”, or an image, such as “wide” and “blue”, evoked by “sea”), similar information to the genre or the kind described above, or the like.

Also, the manuscript analysis unit 112 may use information acquired from an outside in analyzing the manuscript data. For example, the manuscript analysis unit 112 may acquire information existing on the Internet and automatically determine meaning of the word contained in the manuscript data, information evoked by the word, or the like. Also, the manuscript analysis unit 112 may request the preparer to provide information to be used for analysis of the manuscript data. For example, the manuscript analysis unit 112 may request the preparer to provide information regarding a matter of the word contained in the manuscript data or information evoked by the word. Also, the manuscript analysis unit 112 may learn information used in analysis of the manuscript data to update an analysis logic. Accordingly, the manuscript analysis unit 112 can improve analysis accuracy as the manuscript analysis unit 112 is used. The manuscript analysis unit 112 provides the construction generation unit 115 with an analysis result.

(Voice Synthesis Unit 113)

The voice synthesis unit 113 is a functional component that performs voice synthesis processing with use of the manuscript data generated by the manuscript generation unit 111 to generate voice data corresponding to the manuscript data. Meanwhile, a method for the voice synthesis is not particularly limited. For example, the voice synthesis unit 113 can use an arbitrary voice synthesis method such as concatenative voice synthesis and formant synthesis. The voice synthesis unit 113 provides the construction generation unit 115 with the generated voice data.

(Request Management Unit 114)

The request management unit 114 is a functional component that receives a request from the preparer of a program content and manages the request. For example, the request management unit 114 receives various kinds of setting information regarding generation of a program content. Examples of the setting information that the request management unit 114 receives are the genre, the kind, and the template described above without limitation. For example, the setting information may include a targeted person for the program content, broadcast time, the data amount, a screen size, resolution, volume, caption information (for example, whether or not a caption is displayed or a language), and the like. The request management unit 114 provides the construction generation unit 115 with information regarding these requests.

(Construction Generation Unit 115)

The construction generation unit 115 is a functional component that generates an entire construction of a program content. The construction generation unit 115 has a generation logic of a program content achieved by an artificial intelligence technique. More specifically, when information regarding a request of the preparer provided by the request management unit 114, an analysis result provided by the manuscript analysis unit 112, voice data provided by the voice synthesis unit 113, various kinds of information acquired from the below-mentioned storage unit 150, arbitrary information acquired from an outside (including a wearable terminal worn by the viewer, for example) (information regarding time and date, a weather, or a temperature at the time of broadcast, an area for broadcast, sensing data of any of various sensors (for example, an acceleration sensor, a gyro sensor, or a pressure sensor), the viewer's behavior, the viewer's situation (or environment), or the like), or the like is/are input into the generation logic, the construction generation unit 115 outputs a construction of the program content.

The generation logic of the program content learns a large number of program contents in advance to output a construction of the program content that is considered to be optimal based on the above various kinds of information. Meanwhile, the learning method is not particularly limited, and an arbitrary method for use in machine learning can be used.

Here, the “construction” that the construction generation unit 115 generates is a concept including all information constituting the program content such as a matter of manuscript data, a matter or setting of a sound or visual information (for example, voice quality, volume, a method of voice analysis, a matter of BGM, a matter of a moving image or a still image, or an attribute, dress, or facial expression of a character), and a format, a size, security setting (for example, access right), or the like of program content data.

Meanwhile, a construction of a program content generated by the construction generation unit 115 is not limited by various kinds of input information. For example, although the construction generation unit 115 generates a construction of a program content based on an input template, the construction generation unit 115 does not necessarily have to generate a construction corresponding to the template but may generate a new template by partially changing a matter of the template and generate a construction based on the newly generated template. Accordingly, for example, in a case in which an input template partially contains an error, the construction generation unit 115 can generate a template that contains no error based on a previous learning result and thus generate a more appropriate construction of a program content.

In a case in which the construction generation unit 115 determines that manuscript data, voice data, or the like is required to be regenerated (or edited) based on the generated construction of the program content, the construction generation unit 115 may control the manuscript generation unit 111, the manuscript analysis unit 112, and the voice synthesis unit 113 to cause the manuscript generation unit 111, the manuscript analysis unit 112, and the voice synthesis unit 113 to regenerate or analyze the manuscript data or regenerate the voice data. Also, in a case in which the construction generation unit 115 determines that moving image data, still image data, or the like is required to be regenerated (or edited) based on the generated construction of the program content, the construction generation unit 115 may regenerate (or edit) the moving image data, the still image data, or the like. The construction generation unit 115 provides the moving image generation unit 116 with information regarding the construction of the program content, sound data (including voice data), moving image data, or still image data.

(Moving Image Generation Unit 116)

The moving image generation unit 116 is a functional component that automatically generates program content data with use of information regarding a construction of a program content, sound data (including voice data), moving image data, or still image data provided by the construction generation unit 115. More specifically, the moving image generation unit 116 determines a format, a size, security setting (for example, access right), or the like of program content data based on information regarding a construction of a program content and integrates and packages sound data, moving image data, or still image data to generate program content data.

(Communication Unit 120)

The communication unit 120 is a functional component that performs communication with an external device. For example, the communication unit 120 receives from an external device (for example, a WEB server on the Internet) various kinds of information that the control unit 110 uses for generation of program content data (for example, information that the manuscript analysis unit 112 uses for analysis of manuscript data or information that the construction generation unit 115 uses for generation of a construction of the program content). Also, in a case in which the program content data generated by the control unit 110 is to be distributed to the user terminal 200 via an external device, the communication unit 120 transmits the program content data to the external device.

Meanwhile, a communication method of the communication unit 120 is not particularly limited. For example, as a communication method of the communication unit 120, any wired communication method or wireless communication method may be used.

(Input Unit 130)

The input unit 130 is a functional component that receives input by means of the preparer. For example, the input unit 130 includes an input means such as a mouse, a keyboard, a touch panel, and a button, and the preparer performs various operations with use of these input means to cause various kinds of information (for example, a genre, a kind, a template, document data, moving image data, or still image data) to be input.

(Output Unit 140)

The output unit 140 is a functional component that outputs various kinds of information. For example, the output unit 140 includes a display means such as a display and a voice output means such as a loudspeaker and displays various kinds of visual information on the display or the like or generates various sounds through the loudspeaker or the like based on a control signal from the control unit 110.

(Storage Unit 150)

The storage unit 150 is a functional component that stores various kinds of information. For example, the storage unit 150 stores various kinds of information input by the preparer (for example, a genre, a kind, a template, document data, moving image data, or still image data), various kinds of information generated by the distribution apparatus 100 (manuscript data, voice data, moving image data, still image data, program content data, or the like), or the like.

Here, the construction generation unit 115 may update the generation logic by learning previous program content data stored in the storage unit 150. The storage unit 150 also stores a program and a parameter used for various kinds of processing by the distribution apparatus 100. Meanwhile, information that the storage unit 150 stores is not limited to the above.

(4-2. Functional Components of User Terminal 200)

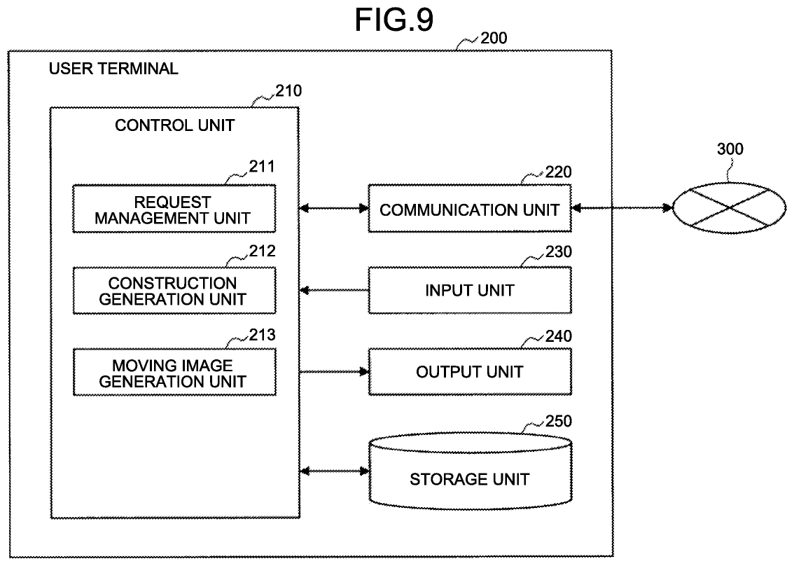

Next, referring to FIG. 9, functional components of the user terminal 200 will be described.

As illustrated in FIG. 9, the user terminal 200 includes a control unit 210, a communication unit 220, an input unit 230, an output unit 240, and a storage unit 250.

(Control Unit 210)

The control unit 210 comprehensively controls overall processing of the user terminal 200. For example, the control unit 210 comprehensively controls automatic generation processing of a program content described below and replays the generated program content data. As illustrated in FIG. 9, the control unit 210 includes a request management unit 211, a construction generation unit 212, and a moving image generation unit 213. Hereinbelow, the respective functional components included in the control unit 210 will be described.

(Request Management Unit 211)

The request management unit 211 is a functional component that receives a request from the viewer of a program content and manages the request. For example, the request management unit 211 receives and manages information regarding a program content selected by the viewer, a request for skipping, repetitively replaying, fast-forwarding, or rewinding the program content that is being replayed, a request for editing the program content data (for example, an attribute of a character, a matter of a caption, a matter of BGM, or a matter of a background), various kinds of setting for watching or listening of the program content (for example, display size, volume, or speed), or the like. The request management unit 211 may manage the information regarding these requests as the viewer's preference information. Meanwhile, information received and managed by the request management unit 211 is not limited to these. The request management unit 211 provides the construction generation unit 212 with information regarding these requests.

(Construction Generation Unit 212)

The construction generation unit 212 is a functional component that generates an entire construction of a program content. As described above, the user terminal 200 can generate a program content with use of the viewer's requests and various kinds of information provided by the distribution apparatus 100. Here, described is an example in which manuscript data, an analysis result thereof, voice data generated based on the manuscript data, or the like is provided by the distribution apparatus 100, and in which the user terminal 200 generates a program content with use of these information pieces.

Similarly to the construction generation unit 115 of the distribution apparatus 100, the construction generation unit 212 has a generation logic of a program content achieved by an artificial intelligence technique. When various kinds of information provided by the distribution apparatus 100 (manuscript data, an analysis result thereof, voice data generated based on the manuscript data, or the like), information regarding a request of the viewer provided by the request management unit 211, various kinds of information acquired from the below-mentioned storage unit 250, arbitrary information acquired from an outside (information regarding time and date, a weather, or a temperature at the time of broadcast, an area for broadcast, or the like), or the like is/are input into the generation logic, the construction generation unit 212 outputs a construction of the program content.

Meanwhile, the user terminal 200 may include similar functional components to the manuscript generation unit 111, the manuscript analysis unit 112, and the voice synthesis unit 113 of the distribution apparatus 100, and the construction generation unit 212 may control these functional components as needed to achieve generation of manuscript data, analysis of the manuscript data, generation of voice data, and the like, although these functional components are not illustrated in FIG. 9. The construction generation unit 212 provides the moving image generation unit 213 with information regarding the construction of the program content, sound data (including voice data), moving image data, or still image data.

(Moving Image Generation Unit 213)

The moving image generation unit 213 is a functional component that automatically generates program content data with use of information regarding a construction of a program content, sound data (including voice data), moving image data, or still image data provided by the construction generation unit 212. More specifically, the moving image generation unit 213 determines a format, a size, security setting (for example, access right), or the like of program content data based on information regarding a construction of a program content and integrates and packages sound data, moving image data, or still image data to generate program content data.

(Communication Unit 220)

The communication unit 220 is a functional component that performs communication with an external device. For example, in a case in which the user terminal 200 downloads and replays program content data generated by the distribution apparatus 100, the communication unit 220 receives the program content data from an external device including the distribution apparatus 100. Also, in a case in which the user terminal 200 generates a program content with use of various kinds of information provided by the distribution apparatus 100, the communication unit 220 receives the various kinds of information from an external device including the distribution apparatus 100. Meanwhile, these information pieces may be received based on an operation by means of the viewer or at predetermined time by the communication unit 220. For example, the communication unit 220 may access the external device including the distribution apparatus 100 at predetermined time and receive new information in a case in which the information is generated.

Meanwhile, a communication method of the communication unit 220 is not particularly limited. For example, as a communication method of the communication unit 220, any wired communication method or wireless communication method may be used.

(Input Unit 230)

The input unit 230 is a functional component that receives input by means of the viewer. For example, the input unit 230 includes an input means such as a touch panel and a button, and the preparer performs various operations with use of these input means to select a program content to watch or listen to and perform various kinds of setting for watching or listening of the program content.

(Output Unit 240)

The output unit 240 is a functional component that outputs various kinds of information. For example, the output unit 240 includes a display means such as a display and a voice output means such as a loudspeaker and displays various kinds of visual information on the display or the like or generates various sounds through the loudspeaker or the like based on a control signal from the control unit 210.

(Storage Unit 250)

The storage unit 250 is a functional component that stores various kinds of information. For example, the storage unit 250 stores program content data and the like. The storage unit 250 may store the viewer's preference information. For example, the storage unit 250 may store, as the viewer's preference information, information regarding various kinds of setting that the viewer has performed for watching or listening of a program content, characteristics of the program content that the viewer has watched or listened to, and the like. The storage unit 250 also stores a program and a parameter used for various kinds of processing by the user terminal 200. Meanwhile, information that the storage unit 250 stores is not limited to the above.

### 5. OPERATION

The functional components of the distribution apparatus 100 and the user terminal 200 according to the present embodiment have been described above. Next, operations of the distribution apparatus 100 and the user terminal 200 will be described.

(5-1. Operation of Distribution Apparatus 100)

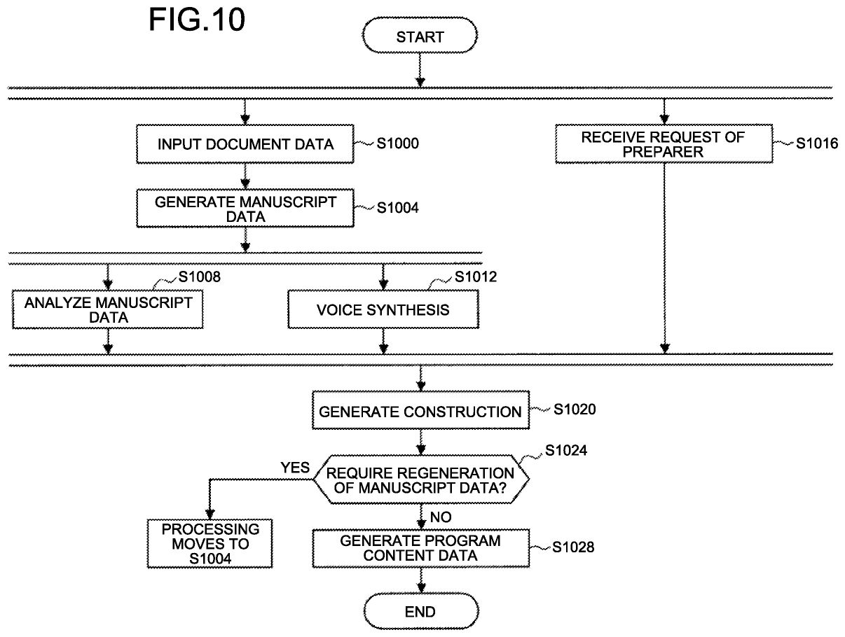

First, referring to FIG. 10, an operation in which the distribution apparatus 100 generates a program content will be described.

In Step S1000, document data is input into the input unit 130 by a preparer of a program content. In Step S1004, the manuscript generation unit 111 generates manuscript data with use of the input document data. In Step S1008, the manuscript analysis unit 112 analyzes the generated manuscript data. Also, in Step S1012, the voice synthesis unit 113 performs voice synthesis processing with use of the manuscript data to generate voice data corresponding to the manuscript data. Meanwhile, although it is assumed that the processing in Step S1008 and the processing in Step S1012 are performed in parallel, the present embodiment is not limited to this.

In Step S1016, the request management unit 114 receives information regarding a request from the preparer such as various kinds of setting information regarding generation of the program content. Although it is assumed that the processing in Step S1016 is performed in parallel with the processing to Step S1012, the present embodiment is not limited to this.

In Step S1020, the construction generation unit 115 inputs into a generation logic the information regarding the request from the preparer provided from the request management unit 114, the analysis result provided from the manuscript analysis unit 112, and the voice data provided from the voice synthesis unit 113 to generate a construction of the program content.

In a case in which the manuscript data is required to be regenerated based on the generated construction of the program content (Step S1024/yes), the processing moves to Step S1004, and the manuscript generation unit 111 regenerates the manuscript data. In a case in which the manuscript data is not required to be regenerated (Step S1024/no), the moving image generation unit 116 generates program content data with use of the information regarding the construction of the program content, sound data (including the voice data), moving image data, or still image data in Step S1028 to end the processing.

(5-2. Operation of User Terminal 200)

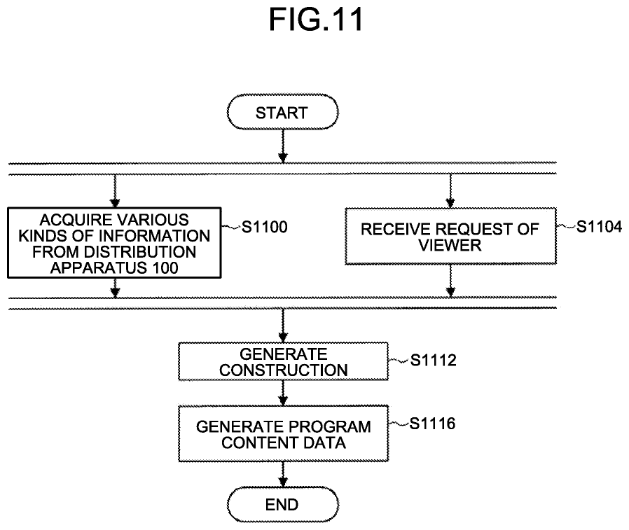

Next, referring to FIG. 11, an operation in which the user terminal 200 generates a program content with use of the various kinds of information provided from the distribution apparatus 100 will be described.

In Step S1100, the construction generation unit 212 acquires via the communication unit 220 the various kinds of information provided from the distribution apparatus 100 for use in generation of the program content (the manuscript data, the analysis result thereof, the voice data generated based on the manuscript data, or the like).

In Step S1104, the request management unit 211 receives information regarding a request from a viewer such as various kinds of setting information regarding generation of the program content. Although it is assumed that the processing in Step S1104 is performed in parallel with the processing in Step S1100, the present embodiment is not limited to this.

In Step S1112, the construction generation unit 212 inputs into a generation logic the various kinds of information provided from the distribution apparatus 100 (the manuscript data, the analysis result thereof, the voice data generated based on the manuscript data, or the like), the information regarding the request from the viewer provided from the request management unit 211, and the like to generate a construction of the program content.

In Step S1116, the moving image generation unit 213 generates program content data with use of the information regarding the construction of the program content to end the processing.

Meanwhile, in a case in which the manuscript data, the voice data, or the like is required to be regenerated, the user terminal 200 may appropriately request the distribution apparatus 100 to regenerate these data pieces or may include similar functional components to the manuscript generation unit 111, the manuscript analysis unit 112, and the voice synthesis unit 113 of the distribution apparatus 100 to regenerate these data pieces, although the processing is not illustrated in FIG. 11.

### 6. HARDWARE CONFIGURATION

The operations of the distribution apparatus 100 and the user terminal 200 according to the present embodiment have been described above. Next, a hardware configuration of the distribution apparatus 100 and the user terminal 200 will be described.

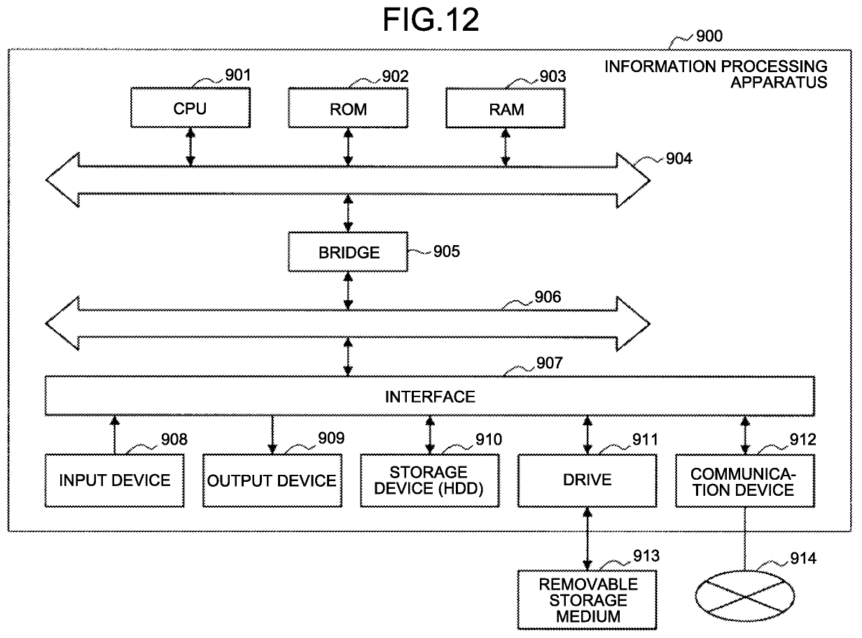

The above various kinds of processing are achieved by cooperation between software and hardware described below. FIG. 12 illustrates a hardware configuration of an information processing apparatus 900 fulfilling the functions of the distribution apparatus 100 and the user terminal 200.

The information processing apparatus 900 includes a central processing unit (CPU) 901, a read only memory (ROM) 902, a random access memory (RAM) 903, a host bus 904, a bridge 905, an external bus 906, an interface 907, an input device 908, an output device 909, a storage device (HDD) 910, a drive 911, and a communication device 912.

The CPU 901 functions as an arithmetic processing unit and a control unit and controls overall operations in the information processing apparatus 900 based on various programs. The CPU 901 may also be a microprocessor. The ROM 902 stores a program, an arithmetic parameter, and the like that the CPU 901 uses. The RAM 903 temporarily stores a program that the CPU 901 uses at the time of execution, a parameter that appropriately changes at the time of the execution, and the like. The CPU 901, the ROM 902, and the RAM 903 are connected to each other by the host bus 904 including a CPU bus or the like. Due to cooperation among the CPU 901, the ROM 902, and the RAM 903, the respective functions of the control unit 110 of the distribution apparatus 100 and the control unit 210 of the user terminal 200 are fulfilled.

The host bus 904 is connected via the bridge 905 to the external bus 906 such as a peripheral component interconnect/interface (PCI) bus. Meanwhile, the host bus 904, the bridge 905, and the external bus 906 do not always need to be provided separately, but the functions of these components may be implemented on one bus.

The input device 908 includes an input means that the user uses to input information such as a mouse, a keyboard, a touch panel, a button, a microphone, a switch, and a lever, an input control circuit that generates an input signal based on input by means of the user and outputs the input signal to the CPU 901, and the like. By operating the input device 908, the user who uses the information processing apparatus 900 can input various kinds of data into the respective devices and instruct the respective devices to perform processing and operations. Due to the input device 908, the respective functions of the input unit 130 of the distribution apparatus 100 and the input unit 230 of the user terminal 200 are fulfilled.

The output device 909 includes a display device such as a cathode ray tube (CRT) display device, a liquid crystal display (LCD) device, an organic light emitting diode (OLED) device, and a lamp. The output device 909 further includes a voice output device such as a loudspeaker and a headphone. The output device 909 outputs a replayed content, for example. Specifically, the display device displays various kinds of information such as replayed video data as text or an image. On the other hand, the voice output device converts replayed voice data into voice and outputs the voice. Due to the output device 909, the respective functions of the output unit 140 of the distribution apparatus 100 and the output unit 240 of the user terminal 200 are fulfilled.

The storage device 910 is a device for data storage. The storage device 910 may include a storage medium, a recording device recording data on the storage medium, a readout device reading out data from the storage medium, a deletion device deleting data recorded on the storage medium, and the like. The storage device 910 includes a hard disk drive (HDD), for example. This storage device 910 drives a hard disk and stores a program that the CPU 901 executes and various kinds of data. Due to the storage device 910, the respective functions of the storage unit 150 of the distribution apparatus 100 and the storage unit 250 of the user terminal 200 are fulfilled.

The drive 911 is a reader/writer for a storage medium and is built in the information processing apparatus 900 or is externally attached. The drive 911 reads out information recorded in a connected removable storage medium 913 such as a magnetic disk, an optical disk, a magneto-optical disk, and a semiconductor memory and outputs the information to the RAM 903. The drive 911 can also write information in the removable storage medium 913.

The communication device 912 is a communication interface including a communication device or the like used to be connected to a communication network 914, for example. Due to the communication device 912, the respective functions of the communication unit 120 of the distribution apparatus 100 and the communication unit 220 of the user terminal 200 are fulfilled.

### 7. CONCLUSION

As described above, the program provision system according to the present disclosure can fulfill a function of automatically generating manuscript data to be broadcasted, a function of automatically generating a sound or visual information of a program content, a function of adapting a sound or visual information to information to be reported, replay time and date, or the like, a function of automatically adding a character's movement, a function of requesting information to be used in automatic generation of a program content, a function of automatically generating a manuscript in accordance with a situation in which a program content is replayed, a function of inserting information of a different matter into a program content that is being replayed, a function of providing a user with a program content that has not been replayed, a function of editing a program content along with a skip or the like, or the like. Accordingly, the program provision system according to the present disclosure can reduce the cost for generating a program content containing a sound or visual information while keeping the quality of the program content high.

Although the preferred embodiment of the present disclosure has been described above in detail with reference to the attached drawings, a technical scope of the present disclosure is not limited to the present embodiment. It is obvious that a person with an ordinary skill in the art to which the present disclosure pertains can easily arrive at various alteration examples or modification examples within the scope of the technical idea disclosed in the claims, and it is to be understood that these examples fall within the technical scope of the present disclosure.

For example, the respective steps illustrated in each of the above flowcharts do not always need to be processed in chronological order in order of each of the illustrated flowcharts. That is, the respective steps may be processed in different order from that illustrated in each of the flowcharts or may be processed in parallel.

Also, the functional components of the distribution apparatus 100 or the user terminal 200 may arbitrarily be changed. For example, some of the functional components of the distribution apparatus 100 or the user terminal 200 may be provided in an external device as needed. Also, the control unit 110 of the distribution apparatus 100 may fulfill some functions of the communication unit 120, the input unit 130, and the output unit 140. Also, the control unit 210 of the user terminal 200 may fulfill some functions of the communication unit 220, the input unit 230, and the output unit 240.

Also, effects described herein are descriptive or illustrative, not limited. That is, the technique according to the present disclosure can exert other effects that are obvious to those skilled in the art based on the present description in addition to or instead of the above effects.

Meanwhile, the following configuration also falls within the technical scope of the present disclosure.

(1)

An information processing apparatus comprising:

a control unit that acquires material data, analyzes a matter of the material data, and automatically generates program content data based on the matter, wherein

the program content data includes visual information.

(2)

The information processing apparatus according to (1), wherein

the program content data includes a moving image or a still image as the visual information.

(3)

The information processing apparatus according to (2), wherein

the program content data includes a moving image or a still image of a character as the visual information.

(4)

The information processing apparatus according to (3), wherein

the control unit controls BGM, a background, or an attribute, dress, facial expression, or a tone of voice of the character based on the matter.

(5)

The information processing apparatus according to (3) or (4), wherein

the control unit controls movement of the character based on the matter.

(6)

The information processing apparatus according to (5), wherein

the control unit controls movement of the character along with a position of a target displayed on the moving image or the still image.

(7)

The information processing apparatus according to any one of (1) to (6), wherein

the material data contains one or two or more document data piece(s), and

the control unit analyzes a matter of the document data piece(s) and automatically generates manuscript data contained in the program content data based on the matter of the document data piece(s).

(8)

The information processing apparatus according to (7), wherein

the control unit edits the document data piece(s) to automatically generate the manuscript data.

(9)

The information processing apparatus according to (8), wherein

the control unit automatically generates the manuscript data based on a replay situation of the program content data.

(10)

The information processing apparatus according to (8) or (9), wherein

the control unit inserts information of a different matter into the manuscript data.

(11)

The information processing apparatus according to (10), wherein

the control unit provides a position enabling the insertion based on a matter of the manuscript data.

(12)

The information processing apparatus according to any one of (1) to (11), wherein

the control unit automatically generates the program content data based on time and date, or an area to replay the program content data, or a season, a weather, or a temperature at time of replay.

(13)

The information processing apparatus according to any one of (1) to (12), wherein

the control unit automatically generates one or two or more program content data piece(s) that has/have approximately equal total replay time to predetermined broadcast time.

(14)

The information processing apparatus according to (13), wherein,

based on a replay situation of the one or two or more program content data piece(s), the control unit automatically edits a part of a replaying program content data piece that has not been replayed or another program content data piece that is scheduled to be replayed or automatically adds another program content data piece that is not scheduled to be replayed.

(15)

The information processing apparatus according to any one of (1) to (14), wherein,

in a case in which, out of information for use in automatic generation of the program content data, insufficient information or inappropriate information exists, the control unit requests a user for information for use in automatic generation of the program content data.

(16)

The information processing apparatus according to any one of (1) to (15), wherein

the control unit informs the user of program content data that has not been replayed or a part of the program content data that has not been replayed.

(17)

An information processing method executed by a computer comprising:

acquiring material data, analyzing a matter of the material data, and automatically generating program content data based on the matter, wherein

the program content data includes visual information.

(18)

A program that causes a computer to fulfill

acquiring material data, analyzing a matter of the material data, and automatically generating program content data based on the matter, wherein

the program content data includes visual information.

### REFERENCE SIGNS LIST

100 distribution apparatus
110 control unit
111 manuscript generation unit
112 manuscript analysis unit
113 voice synthesis unit
114 request management unit
115 construction generation unit
116 moving image generation unit
120 communication unit
130 input unit
140 output unit
150 storage unit
200 user terminal
210 control unit
211 request management unit
212 construction generation unit
213 moving image generation unit
220 communication unit
230 input unit
240 output unit
250 storage unit
300 network

1. An information processing apparatus comprising:
a control unit that acquires material data, analyzes a matter of the material data, and automatically generates program content data based on the matter, wherein
the program content data includes visual information.

2. The information processing apparatus according to claim 1, wherein
the program content data includes a moving image or a still image as the visual information.

3. The information processing apparatus according to claim 2, wherein
the program content data includes a moving image or a still image of a character as the visual information.

4. The information processing apparatus according to claim 3, wherein
the control unit controls BGM, a background, or an attribute, dress, facial expression, or a tone of voice of the character based on the matter.

5. The information processing apparatus according to claim 3, wherein
the control unit controls movement of the character based on the matter.

6. The information processing apparatus according to claim 5, wherein
the control unit controls movement of the character along with a position of a target displayed on the moving image or the still image.

7. The information processing apparatus according to claim 1, wherein
the material data contains one or two or more document data piece(s), and
the control unit analyzes a matter of the document data piece(s) and automatically generates manuscript data contained in the program content data based on the matter of the document data piece(s).

8. The information processing apparatus according to claim 7, wherein
the control unit edits the document data piece(s) to automatically generate the manuscript data.

9. The information processing apparatus according to claim 8, wherein
the control unit automatically generates the manuscript data based on a replay situation of the program content data.

10. The information processing apparatus according to claim 8, wherein
the control unit inserts information of a different matter into the manuscript data.

11. The information processing apparatus according to claim 10, wherein
the control unit provides a position enabling the insertion based on a matter of the manuscript data.

12. The information processing apparatus according to claim 1, wherein
the control unit automatically generates the program content data based on time and date, or an area to replay the program content data, or a season, a weather, or a temperature at time of replay.

13. The information processing apparatus according to claim 1, wherein
the control unit automatically generates one or two or more program content data piece(s) that has/have approximately equal total replay time to predetermined broadcast time.

14. The information processing apparatus according to claim 13, wherein,
based on a replay situation of the one or two or more program content data piece(s), the control unit automatically edits a part of a replaying program content data piece that has not been replayed or another program content data piece that is scheduled to be replayed or automatically adds another program content data piece that is not scheduled to be replayed.

15. The information processing apparatus according to claim 1, wherein,
in a case in which, out of information for use in automatic generation of the program content data, insufficient information or inappropriate information exists, the control unit requests a user for information for use in automatic generation of the program content data.

16. The information processing apparatus according to claim 1, wherein
the control unit informs the user of program content data that has not been replayed or a part of the program content data that has not been replayed.

17. An information processing method executed by a computer comprising:
acquiring material data, analyzing a matter of the material data, and automatically generating program content data based on the matter, wherein
the program content data includes visual information.

18. A program that causes a computer to fulfill
acquiring material data, analyzing a matter of the material data, and automatically generating program content data based on the matter, wherein
the program content data includes visual information.
